(19) United States
(12) Patent Application Publication
(10) Pub. No.: US 2008/0077604 A1
(43) Pub. Date: Mar. 27, 2008

(54) METHODS OF DE IDENTIFYING AN OBJECT DATA

(75) Inventor: Aavishkar Bharara, Delhi (IN)

Correspondence Address: PETER VOGEL;GE HEALTHCARE, 3000 N. GRANDVIEW BLVD., SN-477, WAUKESHA, WI, 53188, US

(73) Assignee: GENERAL ELECTRIC COMPANY, Schenectady, NY (US)

(21) Appl. No.: 11/534,747

(22) Filed: Sep. 25, 2006

(51) Int. Cl. G06F 7/00

(52) U.S. Cl. 707/101

(57) ABSTRACT

In an embodiment, the invention provides a method of de identifying an object data. The method comprises steps of obtaining the object data, the object data being data concerning a medical object, identifying at least one confidential identification data in the object data, the confidential identification data being a confidential data for identifying the medical object, filtering the confidential identification data from the object data and replacing the confidential identification data with at least one standard character.

### FIELD OF INVENTION

The invention relates, in general, to methods of protecting privacy of a medical object when an object data comprising health care information of the medical object is shared between various healthcare entities and, in particular, to methods that de identify an object data to ensure privacy of a medical object.

### BACKGROUND OF THE INVENTION

Picture Archiving and Communication Systems (PACS) are used for acquiring, storing and transmitting medical data obtained in several medical applications. PACS may be used with several technologies for observing the interior anatomy of a medical object, for example with ultrasound, x-ray or PET images and the like. The viewing and analysis of the medical data on the PACS is normally done by a physician and/or a radiologist, at one of several workstations present at a medical facility such as a hospital, clinic or a laboratory. Typically, the medical data is attached with an object identification data for the purpose of associating the medical data with the concerned medical object. The medical data along with the object identification data constitutes a primary object data.

When using the PACS, it may be desirable for the physician and/or the radiologist to provide a dictation report stating the analysis of the medical data. The dictation report provides useful information and is a handy tool in understanding and/or analyzing the primary object data. The information additional to the primary object data, such as dictation reports or voice annotations can be grouped into a secondary object data. The primary object data when combined with the secondary object data constitutes the object data.

The use of object data is important in research for clinical trials, medical object screening, epidemiological studies and other research. Although concern for protecting the privacy of the medical object has always been an issue, the new Health Insurance Portability and Accountability Act (HIPAA) has a significant impact on the use of the object data for research purposes. The HIPAA Privacy Rule allows for certain entities to “de identify” the object data for certain purposes so that such the de identified object data may be used and disclosed freely, without being subject to the protections afforded by the Privacy Rule. The term “de identified data” as used by HIPAA refers to the object data from which all information that could reasonably be used to identify the medical object has been removed (e.g., removing name, address, social security numbers, etc. . . . ). The Privacy Rule requirements do not apply to information that has been de identified.

One of the techniques for de identifying the object data comprises a method for anonymizing a part of the object data such as the medical data. The method does not provide for anonymizing the secondary object data, attached with the medical data.

Another method comprises, separating the primary object data that includes medical data and object identification data, from the secondary object data prior to transmitting the object data to another healthcare organization. In a scenario, where the object data is being transmitted for the purpose of obtaining a second opinion from a second physician in another healthcare facility, the primary object data alone does not provide complete details to the second physician.

The primary limitation in the prior art methods is the inability to provide a masking for the secondary object data that may comprise identification details of the medical object.

Hence there exists a need for providing a method for protecting the privacy of the medical object while sharing the object data concerning the medical object with other healthcare organizations.

### BRIEF DESCRIPTION OF THE INVENTION

The above-mentioned shortcomings, disadvantages and problems are addressed herein which will be understood by reading and understanding the following specification.

In an embodiment, the invention provides a method of de identifying an object data. The method comprises steps of obtaining the object data, the object data being a data concerning a medical object, identifying at least one confidential identification data in the object data, the confidential identification data being a confidential data for identifying the medical object, filtering the confidential identification data from the object data and replacing the confidential identification data with at least one standard character. The standard character is one of a blank notation, a blank character, a zero frequency wave and a blank wave.

In another embodiment, a method of de identifying a secondary object data is provided. The method comprises steps of obtaining the object data, the object data comprising a primary object data and a secondary object data, identifying at least one confidential identification data in the secondary object data, filtering the confidential identification data from the secondary object data and replacing the confidential identification data with at least one standard character.

In yet another embodiment, a computer program product stored in a computer readable media for de identifying an object data is provided. The computer program product comprises a routine for obtaining an object data, a routine for identifying at least one confidential identification data in the object data, a routine for filtering the confidential identification data from the object data and a routine for replacing the confidential identification data with at least one standard character.

Systems and methods of varying scope are described herein. In addition to the aspects and advantages described in the summary, further aspects and advantages will become apparent by reference to the drawings and with reference to the detailed description that follows.

### BRIEF DESCRIPTION OF THE DRAWINGS

FIG. 1 shows a flow diagram of a method de identifying an object data, in an embodiment.

FIG. 2 shows a flow diagram of a method de identifying an object data, in another embodiment.

FIG. 3 shows a flow diagram of a method of de identifying a secondary object data, in another embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The invention provides methods for automatically de identifying an object data thereby protecting the privacy of a medical object associated with the object data. The medical object refers to an article, an object, a person or an animal. The object data relates to a data concerning the medical object. Typically, the object data comprises a primary object data and a secondary object data. The primary object data is a DICOM compliant object data comprising a medical data and an object identification data. The object identification data includes general information concerning the medical object such as identity, age, height, weight, sex, race and family of the medical object.

The medical data is a data that can be collected over the course of diagnosis and treatments. In general the medical data includes genetic medical data, medical history, physical handicaps, known medical conditions, known medical allergies, and current ailment conditions such as symptoms, duration, temperature, blood pressure, pulse rate, blood test data, urine test data, physician observations and the like. Additionally, the medical data may include drug data such as prescriptions, allergy information, drug interaction information, drug treatment information, overdose information and diagnostic data such as radiology information, laboratory information, clinical information, computed tomography (CT) images, ultra sound images, magnetic resonance images, X-ray images, laboratory test results, doctor progress notes, details about medical procedures, radiological reports, other specialist reports, demographic information, and billing (financial) information.

The secondary object data comprises data that is derived from the primary object data. The secondary object data can be a non DICOM compliant object data, auxiliary to the primary object data. Typical examples of the secondary object data include but are not limited a voice clip, an aural annotation, a dictation file and a diagnostic report.

The secondary object data may be entered using a voice dictation system. The voice dictation system is a system for recording voices or voice data, for example a voice dictation device or a speech recognition system. The voice dictation system may use either digital dictation software (saved audio that will be transcribed at a later time) or real time speech recognition.

In an embodiment, the invention describes a method to de identify the object data for communicating the de identified object data within or outside a medical facility such as a hospital, a clinic or a laboratory. The medical facilities can be configured to communicate via a communication standard such as a DICOM standard. Accordingly, the object data can be classified based on the DICOM compatibility. Generally the primary object data, comprising the medical data and the object identification data, is a DICOM compliant object data. The secondary object data includes data that is derived from the primary object data such as voice clip, an aural annotation, a dictation file and a diagnostic report. The secondary object data may include exam notes and miscellaneous text data such as sticky notes. Further, the secondary object data may or may not be a DICOM compliant data.

The object data may be stored in registers, RAM, ROM, or the like, and may be generated through software, through a data storage structure located in a memory device such as RAM or ROM, and so forth. The data storage structure contains a database to store the object data records. The object data extracted from the data storage structure is stripped of the confidential identification data to generate a de identified object data. The de identified object data is stored in a de identified object database. The de identified object database may also be stored as part of the data storage structure or stored in a separate data storage structure.

As used herein, the term “confidential identification data” refers to the object data that is considered confidential and is desired to be protected. The level of protection associated with the confidential identification data may vary from one application to another. Further, the confidential identification data may be a clinically irrelevant data. For example, name of the medical object is a clinically irrelevant data that can be de identified. Whereas other object identification data such as age and sex of the medical object can be clinically relevant for diagnosing the medical object and hence may not be de identified.

Typically, the confidential identification data includes name of the medical object, birth dates and death dates excluding the year, telephone numbers, fax numbers, electronic mail addresses, social security numbers, medical record numbers, health plan beneficiary numbers, account numbers, certificate/license numbers, vehicle identifiers and serial numbers, device identifiers and serial numbers, web universal resource locators (URLs), Internet Protocol (IP) address numbers, biometric identifiers including finger and voiceprints, full face photographic images and any comparable images. Further, the confidential identification data may include zip codes and treatment-related dates.

The de identified object database contains information that may be used by researchers to select potential subjects for medical studies or the like. For example, as part of a research workflow a researcher may need a medical object population comprising females in a selected age range and having certain predetermined medical characteristics. This type of data is available in the de identified object database. However, the de identified object database contains no data that may be traced back to thereby identify a particular medical object.

In an embodiment, the invention provides a method of de identifying the object data by automatically removing at least one confidential identification data from the object data. The confidential identification data may be one of the primary object data and the secondary object data. The de identification process includes a method for replacing the confidential identification data with at least one standard character or a string of standard characters that do not contain information about the medical object. It is noted that each of the standard character may include numerical, alphabetic, alphanumeric and other characters and symbols, conventional or arbitrary, as may be desired. Further, the standard character can be a blank notation, a blank character, a zero frequency wave and a blank wave. Since the standard character strings contain no object identifying information the de identified object data can be made publicly available to a third-party entity and stored in a medical database without compromising on the privacy of the medical object.

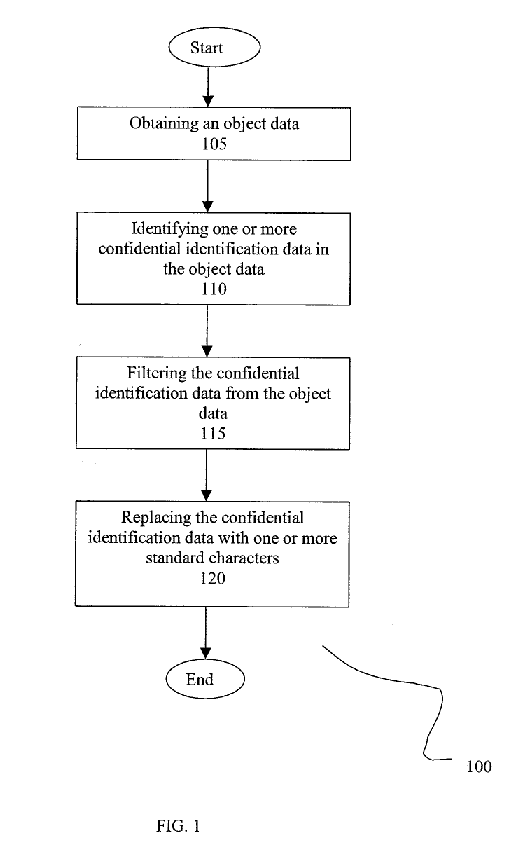

FIG. 1 is a flow diagram illustrating a method of de identifying an object data as described in one embodiment. FIG. 1 illustrates a method by which one or more clinical sites (e.g., hospitals, doctors, etc.) can de identify object data for purposes of disclosing/distributing the de identified object data to one or more third-party entities (e.g., governmental agency, research agency, or medical service provider, etc,) for a particular application, while ensuring privacy of the medical object.

The method as shown in FIG. 1 comprises steps of obtaining the object data step 105, identifying at least one confidential identification data in the object data step 110, filtering the confidential identification data from the object data step 115 and replacing the confidential identification data with at least one standard character step 120.

In an embodiment, each object data can comprise multiple elements. Each element of the object data can be stored in a predetermined memory location of the data storage structure. The method comprises step of obtaining the object data from the data storage structure, identifying the confidential identification data based on the predetermined memory location, filtering the confidential identification data from the object data and replacing the confidential identification data with at least one standard character to generate a de identified object data. The standard character is one of a blank notation, a blank character, a zero frequency wave and a blank wave. The de identified object data can then be used for research purposes.

Alternatively, the object data may be stored in a myriad of unstructured and structured formats. The method of de identifying may include automatically de identifying structured and/or unstructured object data that are included in the object data. The sources that provide structured object data include, for example, financial, laboratory, and pharmacy databases, wherein the object data is typically maintained in database tables. The unstructured object data sources include for example, free-text based documents (e.g., physician reports, etc.), images and waveforms data. Various methods for automatically de identifying the structured and unstructured object data will be discussed in detail below.

In an exemplary embodiment, the invention provides a method of de identifying the structured object data. The structured object data is typically maintained in database tables, wherein the elements of the object data are known a priori and can readily be searched. In general, the process of de identifying the structured object data comprises identifying confidential identification data based on the prior known elements of the object data and replacing the confidential identification data with at least one standard character. Alternatively, multiple DICOM fields containing the confidential identification data are deleted for de identifying the structured object data.

In another exemplary embodiment, the method of de identifying is performed in accordance with the “Safe Harbor” method of the Privacy Rule, in which elements corresponding to the specified attributes in the “Safe Harbor” list are purged from the structured object data.

A next step in the de identification process is to de identify the unstructured object data such as radiology reports, which are included in the object data. The method includes performing a text string search using any suitable keyword searching application to locate various keywords within the object data to be de identified. For example, all text strings within the object data, such as name of the medical object, physician name, and medical object-specific identification numbers or information, can be located, filtered and possibly be replaced with one or more standard characters.

More specifically, in another embodiment, the method of de identifying the object data comprises generating a set of text strings that are to be located in the unstructured object data, based on a list of prior known elements in the structured object data. Thus, the list of prior known elements that are used to identify the confidential identification data in the structured object data can be used to identify confidential identification data in the unstructured object data. The elements of the object data matching the text strings can be categorized as confidential identification data and eliminated from the unstructured object data.

In an exemplary embodiment, the text strings indicating the name of the medical object can be de identified in various manners. For instance, if the name of a medical object is George Bill Antony, then text strings such as “George”, “Antony”, “George Antony”, “George B. Antony”, and “George Bill Antony” can be removed. Furthermore, de identification of the unstructured object data may include searching for name prefixes such as Dr., Mrs., Mr., Ms., Fr., etc, and de identifying the name that follows.

Upon completing the de identification process, the de identified object data may be securely transported from one medical facility to another medical facility by a communications network. Alternatively, the de identified object data records can be stored in the data storage structure.

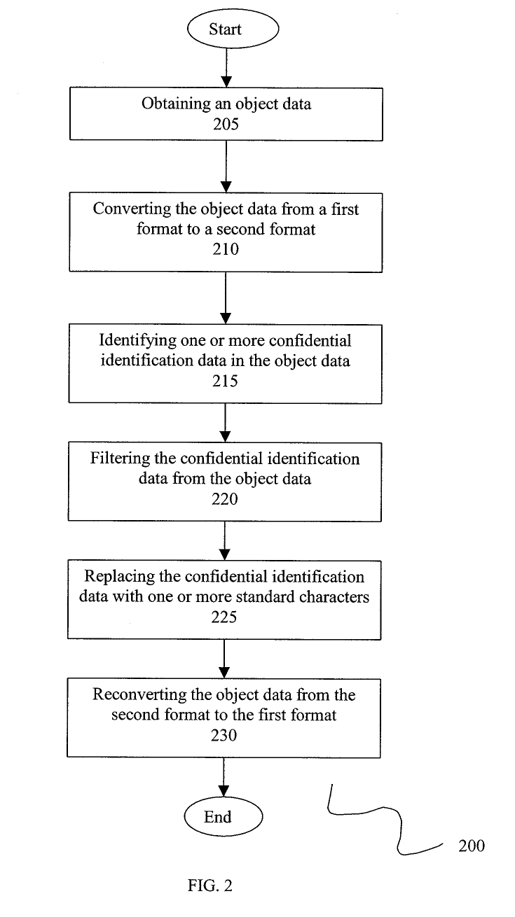

FIG. 2 shows a flow diagram depicting a method of de identifying an object data in another embodiment. The method comprises steps of obtaining an object data step 205, converting the object data from a first format to a second format step 210, identifying at least one confidential identification data in the object data step 215, filtering the confidential identification data from the object data step 220, replacing the confidential identification data with one or more standard characters steps 225 and reconverting the object data from the second format to the first format steps 230.

In an embodiment, the object data can be stored in a particular format such as a voice format, a text format, a waveform format and a frequency format. The method of de identifying the object data may further comprise steps of converting the object data from a first format to a second format and reconverting the object data from the second format to the first format. The first format or the second format may be one of a voice format, a text format, a waveform format and a frequency format.

In an exemplary embodiment, the object data is stored in a voice format. The method comprises steps of fetching the object data from the data storage structure and converting the object data from the voice format to a text format. Many voice to text converting software readily available can be used for converting the object data from the voice format to the text format. The method further comprises steps of identifying the confidential identification data based on the predetermined memory location, filtering the confidential identification data from the object data and replacing the confidential identification data with a standard character such as a blank character to generate a de identified object data. Upon generating the de identified object data, the de identified object data can be reconverted from the text format to the voice format.

In another exemplary embodiment, the object data can be stored in a waveform format. In one particular scenario, the method may comprise steps of converting the object data from a time domain waveform format to a frequency domain waveform format using a technique such as a Fourier transformation. The method further comprises step of identifying at least one confidential identification data in the object data. The object data being present in the frequency domain waveform format, the element of the object data matching a predetermined frequency can be identified as a confidential identification data. The method further comprises steps of filtering the confidential identification data matching the predetermined frequency and replacing the confidential identification data with at least one standard character such as a waveform of a standard frequency. Upon de identifying the object data, the de identified object data is converted from the frequency domain waveform format to the time domain waveform format.

In yet another exemplary embodiment, the object data can be stored in a text format. The method comprises steps of obtaining the object data from the data storage structure, identifying the confidential identification data located at a predetermined memory location, converting the object data from the text format to a waveform format, generating a wave transformation of the confidential identification data, filtering the element of the object data with a waveform substantially similar to the generated wave transformation and replacing the filtered waveform with a waveform of a standard frequency to generate a de identified object data. The de identified object data can be reconverted to the text format and stored in the de identified object database.

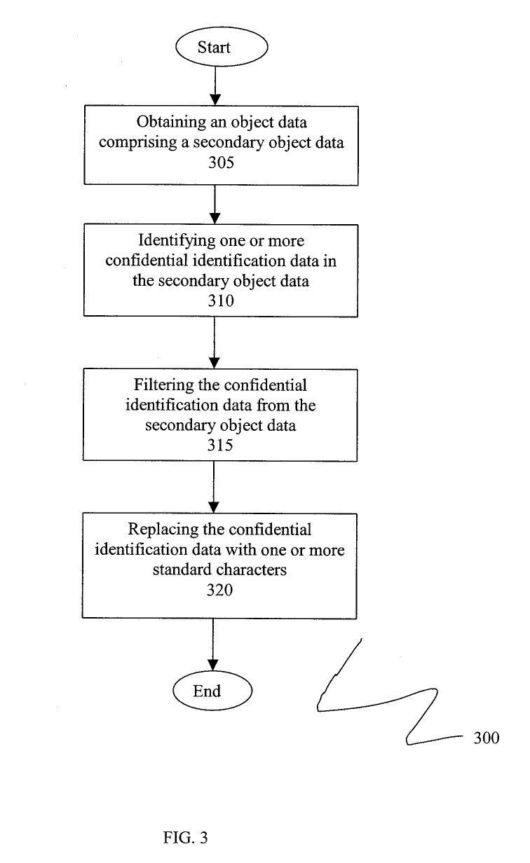

FIG. 3 depicts a flow diagram of a method of de identifying a secondary object data, in another embodiment. The method comprises steps of obtaining the object data comprising the secondary object data step 305, identifying at least one confidential identification data in the secondary object data step 310, filtering the confidential identification data from the secondary object data step 315 and replacing the confidential identification data with at least one standard character step 320.

In an exemplary embodiment, the medical object is a patient. The secondary object data concerning the medical object may comprise a dictation file stating, “patient X is suffering from disease Y”, where X is the name of the patient. The method provided in the invention de identifies the object data comprising the dictation file. During de identification, the name “X” of the patient is replaced by a blank notation as the name of a patient is identified as a confidential identification data. Therefore, when the de identified object data is transmitted to a second doctor in another medical facility, the second doctor hears the de identified dictation clip as “Medical object_is suffering from disease Y”. Hence, the method provided in the invention ensures that identity of the medical object is not disclosed to the second doctor.

The method may further comprise steps of converting the secondary object data from a first format to a second format and reconverting the secondary object data from the second format to the first format. The secondary object data may be stored in one of a voice format, a text format, a waveform format and a frequency format. Accordingly, the standard character is one of a blank notation, a blank character, a zero frequency wave and a blank wave.

In yet another embodiment, the invention provides a computer program product for de identifying an object data. The computer program product comprises a routine for obtaining an object data, a routine for identifying at least one confidential identification data in the object data, a routine for filtering the confidential identification data from the object data and a routine for replacing the confidential identification data with at least one standard character.

The computer program product may further comprise a routine for converting the object data from a first format to a second format and a routine for reconverting the object data from the second format to the first format.

The computer program product can be a tangible record in one or more of a printed document, a computer floppy disk, a computer CD-ROM disk, or any other desired medium. The computer program product can be stored in a computer readable medium, such as a floppy disk or a CD-ROM disk, the medium and other computer readable files.

In general, various embodiments as described herein include methods for protecting privacy of a medical object when an object data concerning the medical object is shared between various entities. The above-description of the embodiments of the methods 100, 200 and 300, and the computer program product have the technical effect of de identifying an object data that helps in protecting the privacy of a medical object, while sharing the object data concerning the medical object with other health care organizations.

It is to be understood that the embodiments described herein may be implemented in various forms of hardware, software, firmware, special purpose processors, or combinations thereof. In one exemplary embodiment, methods described herein are implemented in software as an application comprising program instructions that are tangibly embodied on one or more program storage devices (e.g., hard disk, magnetic floppy disk, RAM, CD Rom, DVD, ROM and flash memory), and executable by any device or machine comprising suitable architecture. It is to be further understood that because the constituent method steps depicted in the accompanying Figures can be implemented in software, the actual flow of the process steps may differ depending upon the manner in which the application is programmed. Given the teachings herein, one of ordinary skill in the related art will be able to contemplate these and similar implementations or configurations of the invention.

The method may be readily implemented in the form of computer software instructions executed by a system in a medical facility. The system may be a computer, an imaging modality such as an ultrasound system, a computed tomography system, a magnetic resonance imaging system and an X ray system, a medical information system such as a laboratory information system (LIS), a clinical information system (CIS), a radiology information system (RIS) and a picture archival and communication system (PACS), an imaging server and the like.

Some of the advantages of the invention, described in various embodiments are listed below.

The methods for de identifying the object data can be implemented for various purposes such as clinical trials, research studies, public health or healthcare operations, while maintaining compliance with regulations based on HIPAA for protecting privacy of the medical object. For example, the method of de identifying an object data may be implemented for monitoring natural or human induced disease outbreaks. In the exemplary embodiment a governmental agency can monitor for natural or human induced disease outbreaks by collecting and analyzing de identified object data from a plurality of different healthcare organizations while ensuring the privacy of the medical object under normal circumstances.

The method includes removing confidential identification information from the object data that can be used to determine the identity of a medical object, or replacing the confidential identification information with a standard character or a group of standard characters. (e.g. replace the actual name with the string “name”). The object data thus de identified, prevents an unauthorized access to the object data by hacking the identification keys used for re identifying the object data. The method provided in the invention removes the confidential identification data altogether and thus there is no mechanism by which identification information of the medical object can be recovered.

The cost of maintaining the de identified object database is much less compared to the conventional methods where multiple encryption and decryption keys are stored for re identifying the object data.

Additionally, the invention provides a method for de identifying secondary object data such as voice clips, aural annotations and dictation files. The secondary object data may further include exam notes, text data such as sticky notes and diagnostic reports. De identifying the secondary object data provides a complete protection to the privacy of the medical object. Hence the object data comprising the secondary object data can be used for various medical applications. Further, the method of de identifying the object data provided in the invention is automatic and no manual intervention is needed.

In various embodiments, methods for automatically de identifying an object data are described. However, the embodiments are not limited and may be implemented in connection with different applications. The application of the invention can be extended to other areas, for example de identification can be used to share any type of protected or private information, while maintaining individual privacy. For instance, de identification method as described herein can be used for enabling schools or colleges or educational agencies, for example, to share student records for any desired application, to enable sharing of employer or employee records, performance appraisals, etc. The invention provides a broad concept of a de identifying a data which can be adapted in a any medical institution, such as a hospital, clinic, research facility, university, pharmaceutical company, governmental organization and the like. Accordingly, the invention is not limited to a hospital setting. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of de identifying an object data, the method comprising:
obtaining the object data, the object data being a data concerning a medical object;
identifying at least one confidential identification data in the object data, the confidential identification data being a confidential data for identifying the medical object;
filtering the confidential identification data from the object data; and
replacing the confidential identification data with at least one standard character.

2. The method of claim 1, wherein the standard character is a blank character.

3. The method of claim 1, wherein the object data comprises a primary object data and a secondary object data.

4. The method of claim 3, wherein the primary object data is a DICOM compliant object data.

5. The method of claim 3, wherein the secondary object data is a non DICOM compliant object data, derived from the primary object data.

6. The method of claim 5, wherein the secondary object data is one of a voice clip, an aural annotation, a dictation file and a diagnostic report.

7. The method of claim 3, wherein the confidential identification data is one of the primary object data and the secondary object data.

8. The method of claim 1, further comprises:
converting the object data from a first format to a second format; and
reconverting the object data from the second format to the first format.

9. The method of claim 8, wherein the first format is one of a voice format, a text format, a waveform format and a frequency format.

10. The method of claim 8, wherein the second format is one of a voice format, a text format, a waveform format and a frequency format.

11. A method of de identifying a secondary object data in an object data, the method comprising:
obtaining the object data, the object data comprising a primary object data and the secondary object data;
identifying at least one confidential identification data in the secondary object data, the confidential identification data being a confidential data for identifying the medical object;
filtering the confidential identification data from the secondary object data; and
replacing the confidential identification data with at least one standard character.

12. The method of claim 11, wherein the standard character is a blank character.

13. The method of claim 11, wherein the primary object data is a DICOM compliant object data.

14. The method of claim 11, wherein the secondary object data is a non DICOM compliant object data, derived from the primary object data.

15. The method of claim 11, wherein the secondary object data is one of a voice clip, an aural annotation, a dictation file and a diagnostic report.

16. The method of claim 11, further comprises:
converting the secondary object data from a first format to a second format; and
reconverting the secondary object data from the second format to the first format.

17. The method of claim 16, wherein the first format is one of a voice format, a text format, a waveform format and a frequency format.

18. The method of claim 16, wherein the second format is one of a voice format, a text format, a waveform format and a frequency format.

19. A computer program product stored in a computer readable media for de identifying an object data, the computer program product comprising:
a routine for obtaining an object data, the object data being data concerning a medical object;
a routine for identifying at least one confidential identification data in the object data, the confidential identification data being a confidential data for identifying the medical object;
a routine for filtering the confidential identification data from the object data; and
a routine for replacing the confidential identification data with at least one standard character.

20. The computer program product of claim 19, wherein the standard character is a blank character.

21. The computer program product of claim 19, wherein the object data comprises a primary object data and a secondary object data.

22. The computer program product of claim 21, wherein the primary object data is a DICOM compliant object data.

23. The computer program product of claim 21, wherein the secondary object data is a non DICOM compliant object data, derived from the primary object data.

24. The computer program product of claim 23, wherein the secondary object data is one of a voice clip, an aural annotation, a dictation file and a diagnostic report.

25. The computer program product of claim 21, wherein the confidential identification data is one of the primary object data and the secondary object data.

26. The computer program product of claim 19, further comprises:
a routine for converting the object data from a first format to a second format; and
a routine for reconverting the object data from the second format to the first format.

27. The computer program product of claim 26, wherein the first format is one of a voice format, a text format, a waveform format and a frequency format.

28. The computer program product of claim 26, wherein the second format is one of a voice format, a text format, a waveform format and a frequency format.
